(19) United States
(12) Patent Application Publication
(10) Pub. No.: US 2023/0207817 A1
(43) Pub. Date: Jun. 29, 2023

(54) NEGATIVE ELECTRODE FOR RECHARGEABLE LITHIUM BATTERY AND RECHARGEABLE LITHIUM BATTERY INCLUDING SAME

(71) Applicants: Samsung SDI Co., Ltd., Yongin-si (KR); Seoul National University R&DB Foundation, Seoul (KR)

(72) Inventors: Jungmin LEE, Yongin-si (KR); Yunshik CHO, Yongin-si (KR); Kiho PARK, Seoul (KR); Jaemin KIM, Seoul (KR); Jang Wook CHOI, Seoul (KR)

(21) Appl. No.: 18/146,041

(22) Filed: Dec. 23, 2022

(30) Foreign Application Priority Data
Dec. 27, 2021 (KR) 10-2021-0188684

(51) Int. Cl. H01M 4/62; H01M 4/04; H01M 10/052

(52) U.S. Cl. CPC H01M 4/622; H01M 4/0404; H01M 10/052; H01M 2004/027

(57) ABSTRACT

A negative electrode for a rechargeable lithium battery and a rechargeable lithium battery including the same are provided. The negative electrode for a rechargeable lithium battery includes a current collector and a negative active material layer on the current collector, wherein the negative active material layer comprises a negative active material, a binder, and a polyhydric alcohol plasticizer having 2 to 5 OH groups per molecule of the polyhydric alcohol plasticizer, and the binder is an aqueous linear polymer binder including a cellulose-based compound, an acrylate-based compound, or a combination thereof.

### CROSS-REFERENCE TO RELATED APPLICATION

This application claims priority to and the benefit of Korean Patent Application No. 10-2021-0188684, filed in the Korean Intellectual Property Office on Dec. 27, 2021, the entire content of which is hereby incorporated by reference.

### BACKGROUND

### 1. Field

Embodiments of the present disclosure relate to a negative electrode for a rechargeable lithium battery and a rechargeable lithium battery including the same.

### 2. Description of the Related Art

Recently, there has been a rapid increase in interest and demand for autonomous vehicles and electrical vehicles. Rechargeable lithium batteries are expected to act as important power sources for electrical vehicles in the future and the technological developments related thereto and thus commercialization have been actively attracted. For example, there is a great amount of attention being paid to rechargeable lithium batteries as they have relatively higher energy density per unit compared to other batteries.

A rechargeable lithium battery generates electrical energy by changing chemical potential during lithiation-delithiation of lithium ions.

Such a rechargeable lithium battery includes a positive electrode, a negative electrode, an electrolyte, and a separator.

A positive active material for a rechargeable lithium battery may include lithium-included metal oxides such as LiCoO₂, LiMnO₂, LiMn₂O₄, or LiFePO₄. As a negative active material, graphite, metal lithium, silicon and/or a graphite-silicon composite, and/or the like may be utilized.

A positive electrode and a negative electrode may also include (e.g., may each include) a conductive material and a binder together with the active material. The inclusion ratio of the binder in the electrode is small, but may be considered as a necessary and an essential element, as it has a great influence on slurry preparation, the coating process and on stable electrochemical behavior.

The above information disclosed in this Background section is only for enhancement of understanding of the background of the present disclosure, and therefore it may contain information that does not form the prior art that is already known to a person of ordinary skill in the art.

### SUMMARY

Aspects of one or more embodiments of the present disclosure are directed towards a negative electrode for a rechargeable lithium battery that maintains a stable negative electrode and increases ionic conductivity in the negative electrode, thereby exhibiting excellent or suitable rate-capability.

Aspects of one or more embodiments are directed towards a rechargeable lithium battery including the negative electrode.

One or more embodiments of the present disclosure provide a negative electrode for a rechargeable lithium battery, including a current collector and a negative active material layer on the current collector, wherein the negative active material layer includes a negative active material, a binder, and a polyhydric alcohol plasticizer having 2 to 5 OH groups per molecule of the polyhydric alcohol plasticizer, and wherein the binder is an aqueous linear polymer binder including (e.g., selected from) a cellulose-based compound, an acrylate-based compound, and/or a combination thereof.

In one or more embodiments, an amount of the polyhydric alcohol plasticizer may be about 5 wt % to about 40 wt % based on 100 wt % of an amount of the binder.

In one or more embodiments, the polyhydric alcohol plasticizer may have a dielectric constant of about 40 or more, or a dielectric constant of about 40 to about 80.

In one or more embodiments, the polyhydric alcohol plasticizer may be glycerol, ethylene glycol, erythritol, 1,2-propanediol, 1,3-propanediol, or a combination thereof.

In one or more embodiments, the binder may be the cellulose-based compound and the cellulose-based compound may be carboxymethyl cellulose, hydroxypropyl methylcellulose, methyl cellulose, or an alkali metal salt thereof.

In one or more embodiments, the binder may be the acrylate-based compound and the acrylate-based compound may be polyacrylic acid, polymethyl methacrylate, polyisobutyl methacrylate, polyethylacrylate, polybutylacrylate, polyethylhexylacrylate, or a combination thereof.

In one or more embodiments, an amount of the binder may be about 0.95 wt % to 9.96 wt % of the total amount of about 100 wt % of the negative active material layer.

In one or more embodiments, the negative electrode may further include an additional binder including (e.g., selected from) an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, a styrene-butadiene rubber (SBR), an acrylated styrene-butadiene rubber (ABR), an acrylonitrile-butadiene rubber, an acryl rubber, a butyl rubber, a fluorine rubber, ethylene oxide-including a polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acryl resin, a phenol resin, an epoxy resin, polyvinyl alcohol, and/or a combination thereof.

In one or more embodiments, a mixing ratio of the binder and the additional binder may be about 5:95 to about 95:5 by weight.

One or more embodiments of the present disclosure provide a rechargeable lithium battery including the negative electrode, a positive electrode, and an electrolyte.

The negative electrode according to one or more embodiments of the present disclosure may maintain a stable structure of the negative electrode and increase ionic conductivity in the negative electrode, thereby exhibiting excellent or suitable rate-capability.

### BRIEF DESCRIPTION OF THE DRAWINGS

FIG. 1 is a schematic view of a rechargeable lithium battery according to one or more embodiments of the present disclosure.

FIG. 2 is a graph showing resistance of a lithium symmetric cell.

FIG. 3 is a graph showing resistance of a stainless steel symmetric cell.

FIG. 4 is a graph showing DSC results of a polymer film of Preparation 1 and Comparative Preparation Example 1.

FIG. 5 is a graph showing adhesion of the negative electrodes according to Example 1 and Comparative Examples 1 and 2.

FIG. 6 is a graph showing rate-capability of the cells according to Example 1 and Comparative Examples 1 and 2.

FIG. 7 is a graph showing rate-capability of the cells according to Examples 1 and 2, and Comparative Example 1.

FIG. 8 is a graph showing impedances of the cells according to Example 1 and Comparative Example 1.

FIG. 9 is images showing leaching test results of the plasticizers according to Preparation Example 2 and Comparative Preparation Example 2.

### DETAILED DESCRIPTION

Hereinafter, embodiments of the present disclosure are described in more detail. The present disclosure, however, may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

These embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terms “combination thereof” may include a mixture, a laminate, a complex, a copolymer, an alloy, a blend, and/or a reactant of constituents.

The terms “comprise”, “include” or “have” are intended to specify the presence of the stated features, integers, steps, operations, elements, and/or components, but do not preclude the presence or addition of one or more other features, integers, steps, operations, elements, components, and/or groups thereof.

In the drawings, the relative sizes of elements, layers, and regions may be exaggerated for clarity. Unless otherwise noted, like reference numerals denote like elements throughout the attached drawings and the written description, and thus, descriptions thereof may not be repeated.

When an element, such as a layer, a film, a region, a plate, and/or the like is referred to as being “on” or “over” another part, it may include cases where it is “directly on” another element, but also cases where there is another element in between. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the singular forms “a,” “an” and “the” are intended to include the plural forms as well, unless the context clearly indicates otherwise. As used herein, the term “and/or” includes any and all combinations of one or more of the associated listed items. Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

“Thickness”, for example, may be measured via an image utilizing an optical microscope, such as scanning electron microscope and/or the like.

In the present disclosure, when particles are spherical, “diameter” indicates a particle diameter or an average particle diameter, and when the particles are non-spherical, the “diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

A negative electrode for a rechargeable lithium battery according to one or more embodiments includes a current collector and a negative active material layer positioned on the current collector, and the negative active material layer includes a negative active material, a binder and a polyhydric alcohol plasticizer having 2 to 5 OH groups per molecule.

The binder may be an aqueous linear polymer binder including (e.g., selected from) a cellulose-based compound, an acrylate-based compound, and/or a combination thereof.

The polyhydric alcohol plasticizer having the 2 to 5 OH groups per molecule may decrease a glass transition temperature of the binder in the negative electrode and enlarge a free volume of the binder, thereby decreasing crystallinity, and as a result reducing resistance and improving ionic conductivity of the negative electrode, while maintaining adhesion of the negative active material layer to the current collector. Therefore, the high rate charging and discharging characteristics of the negative electrode may be improved. Such effects may only be obtained from polyhydric alcohols including 2 to 5 OH groups, and may not be obtained from polyhydric alcohols including 1 or 6 (e.g., sorbitol) OH groups.

An alcohol with one OH group has extremely low boiling point and thus, it may be substantially or completely volatilized and removed during preparation, and thereby not able to act as a plasticizer in an electrode. Furthermore, when the polyhydric alcohol with a six or more of an OH group is utilized as a plasticizer, aggregation of the plasticizer may occur during the negative electrode preparation, which may adversely affect negative electrode stability.

In one or more embodiments, the polyhydric alcohol plasticizer may have a dielectric constant of about 40 or more, or about 40 to about 80. When the dielectric constant of the polyhydric alcohol plasticizer is within this range, such a high dielectric constant may improve a dielectric constant of the binder, a degree of dissociation of ions, and a degree of charge accumulation, and resultantly, the ionic conductivity of the negative electrode may be further improved and the resistance may be reduced.

The polyhydric alcohol plasticizer having 2 to 5 OH groups per a molecule may be glycerol, ethylene glycol, erythritol, 1,2-propanediol, 1,3-propanediol, or a combination thereof.

In one or more embodiments, the polyhydric alcohol plasticizer may be presented in an amount of about 5 wt % to about 40 wt %, or about 15 wt % to about 25 wt % based on 100 wt % of the amount of the binder. As such, the polyhydric alcohol plasticizer is utilized in the negative active material layer in a very small amount and thus, the polyhydric alcohol plasticizer does not act as (e.g., increase) resistance which can cause deterioration of the electrochemical characteristics, and gives suitable plasticizer effects. When an amount of the polyhydric alcohol plasticizer is out of the range(s), it may act as (e.g., increase) resistance in the negative electrode.

An amount of the polyhydric alcohol plasticizer may be about 0.04 wt % to about 4 wt % or about 0.1 wt % to about 3 wt % based on a total 100 wt % of the negative active material layer.

In one or more embodiments, an amount of the binder may be about 0.95 wt % to about 9.96 wt % based on the total, 100 wt % of the negative active material layer. When the amount of the binder is in this range, the more stable negative active material layer may be prepared.

The binder may be a cellulose-based compound, an acrylate-based compound, or a combination thereof.

The cellulose-based compound may be at least one of or a mixture of a carboxymethyl cellulose, a hydroxypropyl methyl cellulose, a methyl cellulose, and/or an alkali metal thereof. The alkali metal may be Na, K, or Li.

The acrylate-based compound may be polyacrylic acid, polymethyl methacrylate, polyisobutyl methacrylate, polyethylacrylate, polybutylacrylate, polyethylhexylacrylate, or a combination thereof.

In one or more embodiments, the negative electrode may further include an additional binder. The additional binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, a styrene-butadiene rubber (SBR), an acrylated styrene-butadiene rubber (ABR), an acrylonitrile-butadiene rubber, an acryl rubber, a butyl rubber, a fluorine rubber, ethylene oxide-including polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

In one or more embodiments, although the negative electrode further includes the additional binder together with the binder, the total amount of the binder and the additional binder may be about 0.95 wt % to about 9.96 wt % based on the total, 100 wt % of the negative active material layer and a weight ratio of the binder and the additional binder may be about 5:95 to about 95:5 weight ratio.

An amount of the negative active material may be about 90 wt % to about 99 wt % based on the total 100 wt % of the negative active material layer, or about 92 wt % to about 99 wt %.

The negative active material may include a material that reversibly intercalates/deintercalates lithium ions, a lithium metal, a lithium metal alloy, a material capable of doping/dedoping lithium or a transition metal oxide.

The material that reversibly intercalates/deintercalates lithium ions may be a carbon material that may be any generally-utilized carbon-based negative active material in a rechargeable lithium (e.g., lithium ion) battery, and examples thereof may be crystalline carbon, amorphous carbon, or a combination thereof. The example of the carbon material may be crystalline carbon, amorphous carbon, or a mixture thereof. The crystalline carbon may be graphite such as unspecified shape, sheet, flake, spherical or fiber shaped natural graphite or artificial graphite. The amorphous carbon may be soft carbon, hard carbon, mesophase pitch carbide, sintered cokes, and/or the like.

The lithium metal alloy may be an alloy of lithium and a metal including (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be Si, a Si—C composite, SiOₓ (0<x<2), a Si-Q alloy (wherein Q is an element including (e.g., selected from) an alkali metal, an alkaline-earth metal, a Group 13 element, a Group 14 element, a Group 15 element, a Group 16 element, a transition metal, a rare earth element, and/or a combination thereof, and not Si), Sn, SnO₂, a Sn—R alloy (wherein R is an element including (e.g., selected from) an alkali metal, an alkaline-earth metal, a Group 13 element, a Group 14 element, a Group 15 element, a Group 16 element, a transition metal, a rare earth element, and/or a combination thereof, and not Sn), and/or the like. At least one of these materials may be mixed with SiO₂. The elements Q and R may include (e.g., may be selected from) Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and/or a combination thereof.

The transition elements oxide may be vanadium oxide, lithium vanadium oxide, lithium titanium oxide, and/or the like.

The Si—C composite may include silicon particles and a carbon-based material. The silicon particle may have an average particle diameter D50 of about 10 nm to about 200 nm. The Si—C composite may further include an amorphous carbon layer formed on at least a portion thereof. In the present disclosure, when a definition is not otherwise provided, such a particle diameter (D50) indicates an average particle diameter (D50) where a cumulative volume is about 50 volume % in a particle distribution.

The carbon-based material may be amorphous carbon or crystalline carbon. The example of the composite may include a core in which Si particles and a first carbon-based material are mixed and may include a second carbon-based material that surrounds (e.g., is around) the core. The first carbon-based material and the second carbon-based material may be the same or different, and may be amorphous carbon or crystalline carbon. The amorphous carbon may be pitch carbon, soft carbon, hard carbon, mesophase pitch carbide, sintered cokes, carbon fiber, or a combination thereof, and the crystalline carbon may be artificial graphite, natural graphite, or a combination thereof.

According to one or more embodiments, the negative active material may be at least two negative active materials, and for example, may include the Si-carbon composite as a first negative active material and crystalline carbon as a second negative active material. When the negative active material includes at least two negative active materials, the mixing ratio thereof may be suitably controlled or selected, but it may be desired or suitable to control until an amount of Si is about 3 wt % to about 50 wt % based on the total weight of the negative active material.

The current collector may Include (e.g., may include one selected from) a copper foil, a nickel foil, a stainless steel foil, a titanium foil, a nickel foam, a copper foam, a polymer substrate coated with a conductive metal, and/or a combination thereof.

One or more embodiments provide a rechargeable lithium battery including the negative electrode, a positive electrode, and an electrolyte.

The positive electrode may include a current collector and a positive active material layer formed on the current collector.

The positive active material may include lithiated intercalation compounds that reversibly intercalate and deintercalate lithium ions. For example, one or more composite oxides of a metal including (e.g., selected from) cobalt, manganese, nickel, and/or a combination thereof, and lithium may be utilized. In one or more embodiments, the compounds represented by one of the following chemical formulae may be utilized: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤5c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.5, 0≤α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0≤α≤2); LiₐNi_{1-b-c}Mn_{b}X_{c}O_{2-α}T_{α} (0.90≤a≤1.8, 0≤b≤0.5, 0≤c≤0.5, 0<a<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, ≤b≤0.9, 0≤c≤90.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, ≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulae, A includes (e.g., is selected from) Ni, Co, Mn, and/or a combination thereof; X include (e.g., is selected from) Al, Ni, Co, Mn, Cr, Fe, Mg, Sr, V, a rare earth element, and/or a combination thereof; D includes (e.g., is selected from) O, F, S, P, and/or a combination thereof; E includes (e.g., is selected from) Co, Mn, and/or a combination thereof; T includes (e.g., is selected from) F, S, P, and/or a combination thereof; G includes (e.g., is selected from Al, Cr, Mn, Fe, Mg, La, Ce, Sr, V, and/or a combination thereof; Q includes (e.g., is selected from) Ti, Mo, Mn, and/or a combination thereof; Z includes (e.g., is selected from) Cr, V, Fe, Sc, Y, and/or a combination thereof; and J includes (e.g., is selected from) V, Cr, Mn, Co, Ni, Cu, and/or a combination thereof.

The compounds may have a coating layer on the surface, or may be mixed with another compound having a coating layer. The coating layer may include at least one coating element compound including (e.g. selected from) an oxide of a coating element, a hydroxide of a coating element, an oxyhydroxide of a coating element, an oxycarbonate of a coating element, and/or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by utilizing these elements in the compound. For example, the method may include any coating method such as spray coating, dipping, and/or the like, which are generally available in the related field.

In the positive electrode, an amount of the positive active material may be about 90 wt % to about 98 wt % based on the total weight of the positive active material layer.

In one or more embodiments, the positive active material layer may further include a binder and a conductive material. Herein, the binder and the conductive material may be included in an amount of about 1 wt % to about 5 wt %, respectively, based on the total amount of the positive active material layer.

The binder improves binding properties of positive active material particles with one another and with a current collector. Examples thereof may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene butadiene rubber, an acrylated styrene butadiene rubber, an epoxy resin, nylon, and/or the like, but the present disclosure is not limited thereto.

The conductive material is included to provide electrode conductivity. Any electrically conductive material may be utilized as a conductive material unless it causes a chemical change. Examples of the conductive material may include a carbon-based material such as natural graphite, artificial graphite, carbon black, acetylene black, ketjen black, a carbon fiber and/or the like; a metal-based material of a metal powder or a metal fiber including copper, nickel, aluminum, silver, and/or the like; a conductive polymer such as a polyphenylene derivative; or a mixture thereof.

The current collector may utilize Al, but the present disclosure is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. The alcohol-based solvent may include ethyl alcohol, isopropyl alcohol, and/or the like, and examples of the aprotic solvent include nitriles such as R—CN (where R is a C2 to C20 linear, branched, or cyclic hydrocarbon, or may include a double bond, an aromatic ring, or an ether bond), amides such as dimethylformamide, dioxolanes such as 1,3-dioxolane, sulfolanes, and/or the like.

The organic solvent may be utilized alone or in a mixture. When the organic solvent is utilized in a mixture, the mixture ratio may be controlled or selected in accordance with a desirable battery performance.

The carbonate-based solvent may include a mixture with a cyclic carbonate and a linear carbonate. The cyclic carbonate and linear carbonate are mixed together in a volume ratio of about 1:1 to about 1:9. When the mixture is utilized as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

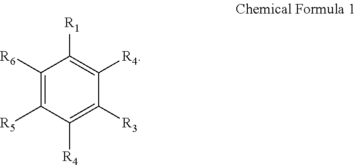

In Chemical Formula 1, R₁ to R₆ may each independently be the same or different and include (e.g., are selected from) hydrogen, a halogen, a C1 to C10 alkyl group, a haloalkyl group, and/or a combination thereof.

Specific examples of the aromatic hydrocarbon-based organic solvent may include (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte may include vinyl ethyl carbonate, vinylene carbonate, or an ethylene carbonate-based compound represented by Chemical Formula 2, as an additive for improving cycle life.

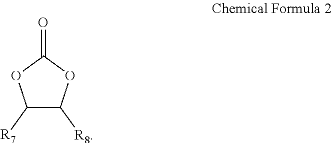

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and/or R₈ is a halogen, a cyano group (CN), a nitro group (NO₂), or a C1 to C5 fluoroalkyl group, and R₇ and R₈ are not concurrently (e.g., simultaneously) hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. An amount of the additive for improving the cycle-life characteristics may be utilized within an appropriate or suitable range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one supporting salt of (e.g., one supporting salt selected from) LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAIO₂, LiAlCl₄, LiPO₂F₂, LiN (CₓF₂ₓ₊₁SO₂)(C_{y}F_{2y+1}SO₂), where x and y are natural numbers, for example, an integer of about 1 to about 20, lithium difluoro(bisoxolato) phosphate), LiCl, LiI, LiB(C₂O₄)₂ (lithium bis(oxalate) borate: LiBOB) and/or lithium difluoro(oxalate)borate (LiDFOB). A concentration of the lithium salt may range from about 0.1 M to about 2.0 M. When the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

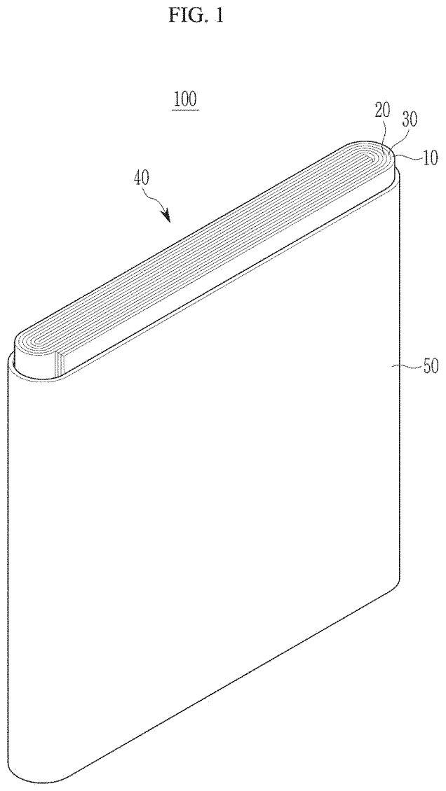

FIG. 1 is an exploded perspective view of a rechargeable lithium battery according to one or more embodiments of the present disclosure. The rechargeable lithium battery according to one or more embodiments is illustrated as a prismatic battery but the present disclosure is not limited thereto and may include variously or suitably-shaped batteries such as a cylindrical battery, a pouch battery, and/or the like.

Referring to FIG. 1, a rechargeable lithium battery 100 according to one or more embodiments may include an electrode assembly 40 manufactured by winding a separator 30 disposed between a positive electrode 10 and a negative electrode 20, and a case 50 housing the electrode assembly 40. An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### Example 1

Glycerol with a dielectric constant of about 42.5 was added to a water solvent to prepare a glycerol aqueous solution with a concentration of an about 10 wt %.

An artificial graphite negative active material, a carboxymethyl cellulose aqueous solution with a concentration of about 1 wt % and the glycerol aqueous solution were mixed and a styrene-butadiene rubber aqueous solution with a concentration of about 40 wt % was admixed to the resulting mixture to prepare a negative active material layer composition. Herein, in the prepared negative active material layer composition, as a solid amount, a mixing ratio of the artificial graphite negative active material, carboxymethyl cellulose and styrene-butadiene rubber was to be about 97.8:1:1.2 weight ratio and amount of glycerol was to be about 20 wt % of the amount of the carboxymethyl cellulose.

The negative active material layer composition was coated on the copper current collector and dried at a condition of 110° C. and an atmospheric pressure for about 10 minutes and in a 60° C. vacuum oven for a day to prepare a negative electrode.

For the electrode, utilizing a lithium metal and an electrolyte, a coin-type or kind half-cell was fabricated by a generally available procedure. As the electrolyte, 10 wt % of fluoroethylene carbonate added to a 1 M LiPF₆ dissolved in a mixed solvent of ethylene carbonate and diethyl carbonate (1:1 volume ratio) based on 100 wt % of the mixed solvent, was utilized.

### Example 2

A coin-type or kind half-cell was fabricated by the same procedure as in Example 1, except that a glycerol aqueous solution with a concentration of about 10 wt % according to Example 1 was utilized to change a mixing ratio of an artificial graphite negative active material, carboxymethyl cellulose and styrene-butadiene rubber to be about 97.8:1:1.2 weight ratio and an amount of glycerol to be about 40 wt % of the amount of the carboxymethyl cellulose, as the solid amount.

### Comparative Example 1

An artificial graphite negative active material, and a carboxymethyl cellulose aqueous solution with a concentration of about 1 wt % were mixed and a styrene-butadiene rubber aqueous solution with a concentration of about 40 wt % was admixed to the resulting mixture to prepare a negative active material layer composition. Herein, in the prepared negative active material layer composition, as a solid amount, a mixing ratio of the artificial graphite negative active material, carboxymethyl cellulose and styrene-butadiene rubber was about a 97.8:1:1.2 weight ratio.

Using the negative active material layer composition, a negative electrode and a coin-type or kind half-cell was fabricated by the same procedure as in Example 1.

### Comparative Example 2

A negative electrode and a half-cell were fabricated by the same procedure as in Example 1, but with a sorbitol aqueous solution with a 10 wt % concentration in which sorbitol with a dielectric constant of about 33.5 was added to a water solvent was utilized, instead of the glycerol aqueous solution with a 10 wt % concentration.

### Experimental Example 1) Measurement of Impedance of a Polymer Film

Glycerol was added to a carboxymethyl cellulose aqueous solution with a 1 wt % concentration to prepare a polymer liquid according to Preparation Example 1. Herein, an amount of the glycerol was 20 wt % of carboxymethyl cellulose and thus, the weight ratio of carboxymethyl cellulose and glycerol was a 1:0.2 weight ratio.

A 1 wt % carboxymethyl cellulose aqueous solution was utilized as a polymer liquid according to Comparative Preparation Example 1.

A filter paper with a 18 pi (diameter: 18 mm) size was utilized as a supporter, and the supporter was immersed in the polymer liquids according to Preparation Example 1 and Comparative Preparation Example 1. The obtained product was dried at 60° C. in an oven for a day to prepare a polymer film.

The polymer film was interposed between the two lithium metals and a lithium symmetric cell was made utilizing the electrolyte according to Example 1.

Furthermore, the polymer film was interposed between the two stainless steels and a stainless steel symmetric cell was made utilizing the electrolyte according to Example 1.

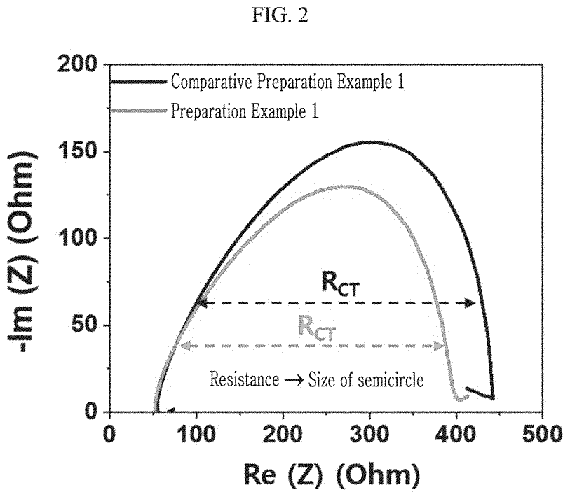

A resistance in the cell for the lithium symmetric cell by the impedance analysis was measured. The results are shown in FIG. 2.

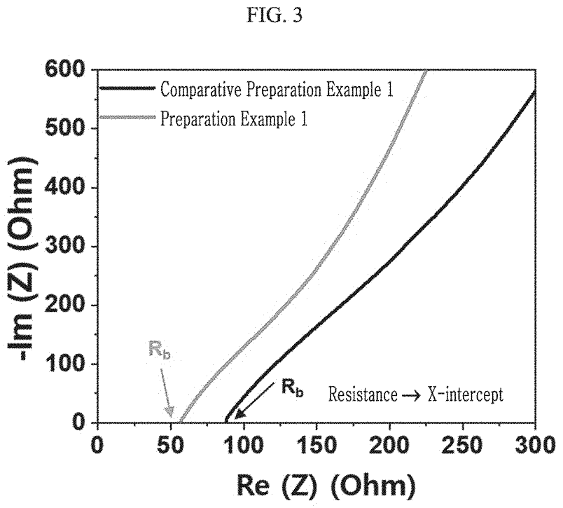

A resistance in the cell for the stainless steel symmetric cell by the impedance analysis was measured. The results are shown in FIG. 3.

As shown in FIG. 2, the utilization of glycerol reduces a size of a semicircle and decreases the resistance as shown in FIG. 3, so that the effects for reducing resistance utilizing glycerol may be clearly shown.

### Experimental Example 2) Analysis of Differential Scanning Calorimetry (DSC)

Calorific values for the polymer films according to Preparation Example 1 and Comparative Preparation Example 1 were measured utilizing a differential scanning calorimetry (DSC) device. The difference scanning calorimetry analysis was performed by increasing a temperature to 200° C. from 30° C. at an increasing rate of 10° C./minute to measure a change in calorimetry.

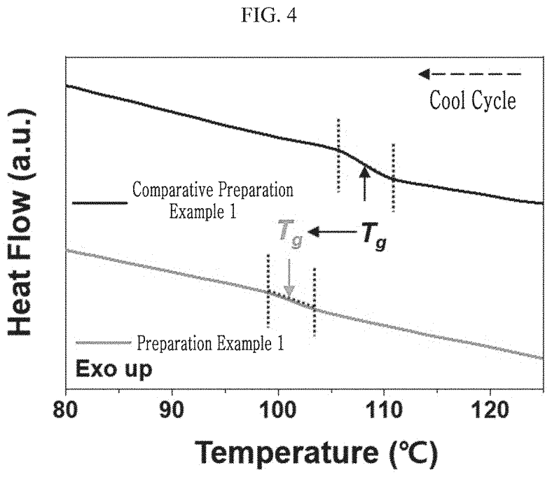

The results are shown in FIG. 4. As shown FIG. 4, the exothermic value of the polymer film according to Preparation Example 1 was smaller than Comparative Preparation Example 1, and had a glass transition temperature of 101° C. which was lower than Comparative Preparation Example 1 of 109° C.

### Experimental Example 3) ‘Low Frequency Dielectric Constant Analysis

Low frequency dielectric constants for the polymer films of Preparation Example 1 and Comparative Preparation Example 1 were measured at 13 MHz by a ASTM D150 method. The results are shown in Table 1.

TABLE 1

| | Dielectric constant(F/m) |
|---|---|
| Comparative Preparation Example 1 | 8.46 |
| Preparation Example 1 | 11.47 |

As shown in Table 1, the polymer film of Preparation Example 1 in which glycerol was added, exhibited a higher dielectric constant than Comparative Preparation Example 1 in which glycerol was not added.

### Experimental Example 4) Measurement of Adherence

An adhesion of the negative electrode according to Example 1, and Comparative Examples 1 and 2 were measured as described below.

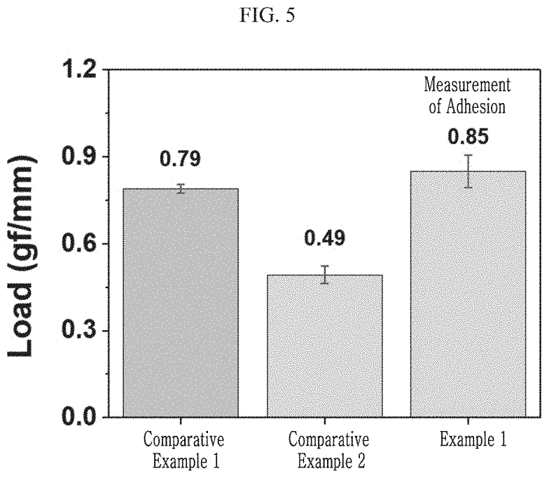

A tape attached to a glass slide was attached to the negative active material layer of the negative electrode, and then an adhesion was measured by separating the tape from the negative active material layer utilizing a 180° UTM tensile strength tester (i.e., a 180° universal tensile tester). Herein, the speed for separation was set to 10 mm/min. The results are shown in FIG. 5.

As shown in FIG. 5, the negative electrode of Example 1 utilizing glycerol exhibited most excellent or suitable adherence. Whereas, Comparative Example 2 utilizing sorbitol exhibited lower adhesion than Comparative Example 1 which did not use a plasticizer.

### Experimental Example 5) Evaluation of Rate Capability Characteristic

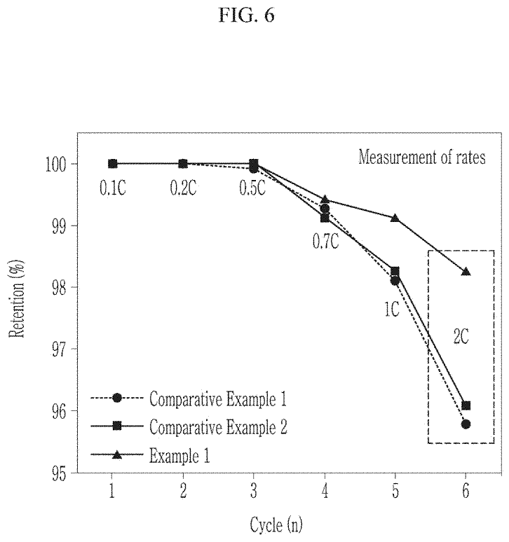

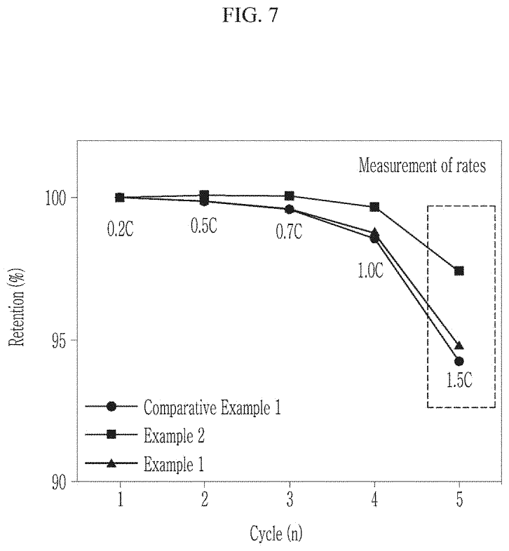

The cells according to Examples 1 and 2, and Comparative Examples 1 and 2 were charged and discharge at 0.1 C once, charged and discharged at 0.2 C once, charged and discharged at 0.5 C once, charged and discharged at 0.7 C once, charged and discharged at 1 C once, and charged and discharged at 2 C once. The ratio of discharge capacity to charge capacity at each rate were obtained. The results of Example 1 and Comparative Examples 1 and 2 are shown in FIG. 6, and the results of Examples 1 and 2, and Comparative Example 1 are shown in FIG. 7.

As shown in FIG. 6 and FIG. 7, as the rate was increased, Examples 1 and 2 exhibited higher capacity retention, and particularly, Examples 1 and 2 exhibited surprisingly higher capacity retention than Comparative Example 1 and 2 at a high rate of 2 C. From these results, the polyhydric alcohol including six OH groups per molecule as a plasticizer exhibited similar high-rate characteristics compared to negative active material layers which did not use the polyhydric alcohol including six OH groups per molecule.

### Experimental Example 6) Measurement of Electrochemical Impedance

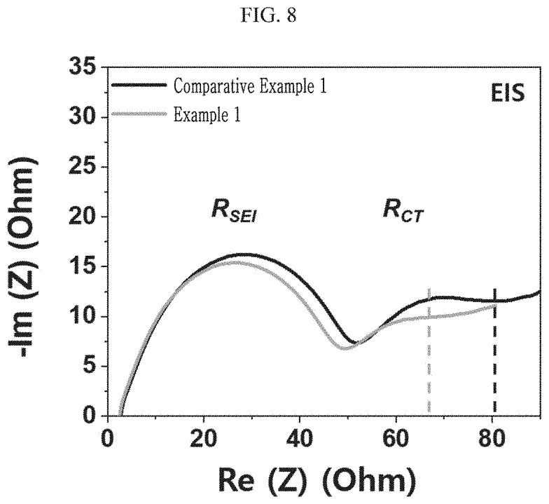

The impedance of the cells according to Example 1 and Comparative Example 1 were measured by an EIS (electrochemical impedance spectroscopy) method in a frequency range of 1 MHz to 0.01 Hz. The results are shown in FIG. 8.

In FIG. 8, the first semi-circle indicates resistance (R_{SEI}) by a SEI layer formed on the negative electrode and the second semi-circle indicates charge transfer resistance (R_{CT}).

As shown in FIG. 8, Preparation Example 1 utilizing a glycerol plasticizer exhibited both (e.g., simultaneously) low R_{SEI} and R_{CT} compared to Comparative Example 1, and particularly, low R_{CT} which allows the active transfer of electrons.

### Experimental Example 7) Test for Leaching a Plasticizer

Glycerol was added to a 1 wt % carboxymethyl cellulose aqueous solution to prepare a mixture, and the mixture was dried to prepare a film of Preparation Example 2. An amount of glycerol was the same with an amount of carboxymethyl cellulose, and thus, a weight ratio of carboxymethyl cellulose and glycerol was 1:1.

The film of Preparation Example 2 was immersed in the electrolyte of Example 1 and kept for 3 days.

Glycerol was added to the electrolyte of Example 1 and kept for 3 days. Herein, an added amount of glycerol was controlled or selected to have a mixing ratio of the electrolyte and glycerol being a 1:1 weight ratio. The result was Comparative Preparation Example 2.

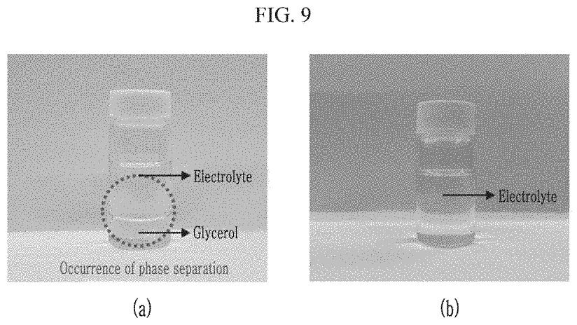

After, the image result of Comparative Preparation Example 2 is shown in (a) of FIG. 9 and the image result of Preparation Example 2 is shown in (b) of FIG. 9, respectively. As shown in (a) of FIG. 9, the low solubility of glycerol to the electrolyte caused phase separation to occur.

Whereas, as shown in (b) of FIG. 9, the utilization of glycerol together with carboxymethyl cellulose do not cause phase separation to occur. From the results, glycerol was stably positioned in the film. These indicated that the utilization of glycerol together with carboxymethyl cellulose prevents or reduces elution to the electrolyte and allows it to be stably present in the negative electrode.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the present disclosure is not limited to the disclosed embodiments, but is intended to cover suitable modifications and equivalent arrangements included within the spirit and scope of the appended claims and equivalents thereof.

What is claimed is:

1. A negative electrode for a rechargeable lithium battery, the negative electrode comprising:
a current collector; and
a negative active material layer on the current collector,
wherein the negative active material layer comprises a negative active material, a binder, and a polyhydric alcohol plasticizer having 2 to 5 OH groups per molecule of the polyhydric alcohol plasticizer, and
wherein the binder is an aqueous linear polymer binder comprising a cellulose-based compound, an acrylate-based compound, or a combination thereof.

2. The negative electrode of claim 1, wherein an amount of the polyhydric alcohol plasticizer is about 5 wt % to about 40 wt % based on 100 wt % of an amount of the binder.

3. The negative electrode of claim 1, wherein the polyhydric alcohol plasticizer has a dielectric constant of about 40 or more.

4. The negative electrode of claim 1, wherein the polyhydric alcohol plasticizer has a dielectric constant of about 40 to about 80.

5. The negative electrode of claim 1, wherein the polyhydric alcohol plasticizer is glycerol, ethylene glycol, erythritol, 1,2-propanediol, 1,3-propanediol, or a combination thereof.

6. The negative electrode of claim 1, wherein the binder comprises the cellulose-based compound and the cellulose-based compound is carboxymethyl cellulose, hydroxypropyl methyl cellulose, methyl cellulose, or an alkali metal salt thereof.

7. The negative electrode of claim 1, wherein the binder comprises the acrylate-based compound and the acrylate-based compound is polyacrylic acid, polymethylmethacrylate, polyisobutyl methacrylate, polyethylacrylate, polybutylacrylate, polyethylhexylacrylate, or a combination thereof.

8. The negative electrode of claim 1, wherein an amount of the binder is about 0.95 wt % to about 9.96 wt % based on a total amount of about 100 wt % of the negative active material layer.

9. The negative electrode of claim 1, wherein the negative electrode further comprises an additional binder selected from an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, a styrene-butadiene rubber (SBR), an acrylated styrene-butadiene rubber (ABR), an acrylonitrile-butadiene rubber, an acryl rubber, a butyl rubber, a fluorine rubber, an ethylene oxide-comprising a polymer, polyvinylpyrrolidone, polypropylene, polyepichlorohydrin, polyphosphazene, an ethylene propylene dienecopolymer, polyvinylpyridine, chlorosulfonated polyethylene, latex, a polyester resin, an acryl resin, a phenol resin, an epoxy resin, polyvinyl alcohol and combinations thereof.

10. The negative electrode of claim 9, wherein a mixing ratio of the binder to the additional binder is about 5:95 to about 95:5 by weight.

11. A rechargeable lithium battery comprising:
the negative electrode of claim 1;
a positive electrode; and
an electrolyte.
